(19) United States
(12) Patent Application Publication
(10) Pub. No.: US 2015/0264460 A1
(43) Pub. Date: Sep. 17, 2015

(54) SPEAKER SYSTEM AND VIDEO DISPLAY DEVICE

(71) Applicant: SHARP KABUSHIKI KAISHA, Osaka-shi, Osaka (JP)

(72) Inventor: Kenji Yanagihara, Osaka-shi (JP)

(73) Assignee: SHARP KABUSHIKI KAISHA, Osaka-shi, Osaka (JP)

(21) Appl. No.: 14/434,492

(22) PCT Filed: Oct. 23, 2013
(86) PCT No.: PCT/JP2013/078709

§ 371 Date: Apr. 9, 2015

(30) Foreign Application Priority Data
Oct. 23, 2012 (JP) 2012-233492

(51) Int. Cl. H04R 1/02

(52) U.S. Cl. CPC H04R 1/028; H04R 2499/15

(57) ABSTRACT

By providing a configuration which effectively limits the band of sound emitted from speakers without having to configure a network circuit, this speaker system achieves acoustic features of high sound quality without relying on listening points. This speaker system has two speakers for each channel that emit sound in different bands, and has a shielding object which, when the sound emission direction along the speaker axis of each speaker is set to forwards, is in front of a mid-range speaker which emits sound in a relatively low band.

### TECHNICAL FIELD

The present invention relates to a speaker system and a video display device, and more specifically relates to a speaker system that has two speakers for one amplifier channel, each of which emits a sound in a different band, and a video display device provided with the aforementioned speaker system.

### BACKGROUND OF THE INVENTION

These days, a mainstream video display device, for example, such as a television receiver in which a speaker is embedded, is one that is a thin type and subjected to frame-narrowing from a viewpoint of enhancing designability thereof. The frame-narrowing means to reduce a so-called frame around a display screen as much as possible by narrowing a width of the frame around the display screen of a liquid crystal panel or the like. In accordance with such thinning and frame-narrowing, restriction in designing is caused also in the case of installing the speaker, so that a range for selection of the speaker is extremely narrow. However, in spite of such designing restriction, a speaker system which improves deterioration in sound quality and is able to achieve high-quality acoustic features is sought.

As a technology for improving sound quality without enlarging a speaker system, for example, a speaker which aims to control directivity without changing external dimensions of the speaker is disclosed in Patent Literature 1. This speaker is for outputting sounds by a diaphragm, and a sound adjustment member, which is provided between a first part of the diaphragm and a listening position by a user, adjusts interference of sounds output from the first part to sounds output from a second part of the diaphragm to be transmitted to the listening position.

### PRIOR ART DOCUMENT

### Patent Document

### Patent Document 1: Japanese Laid-Open Patent Publication No. 2009-141884

### SUMMARY OF THE INVENTION

### Problem to be Solved by the Invention

For example, in a speaker system mounted in a television receiver or the like, a mid-range speaker which emits a sound in a relatively low-frequency side and a tweeter which emits a sound in a relatively high-frequency side are used in some cases for expanding a reproducible frequency band and achieving acoustic features having high quality.

However, by the above-described restriction in designing due to a requirement of the thinning and the frame-narrowing of the television receiver, a band of the sound emitted from the mid-range speaker is often overlapped with a band of the sound emitted from the tweeter.

FIG. 8 is a diagram showing one example of sound pressure features of a mid-range speaker and a tweeter, and, in the diagram, M shows one example of the sound pressure features of the mid-range speaker and T shows that of the sound pressure features of the tweeter.

As sown in FIG. 8, in a speaker system in which the mid-range speaker and the tweeter are used, a phenomenon occurs that bands which respective speakers are in charge of, that is, bands of sounds emitted from respective speakers overlap in almost the same sound pressure level. In the example of FIG. 8, for example, in a band indicated with A, wavelength ranges of almost the same sound pressure levels are overlapped.

Thereby, the sounds emitted from the both speakers interfere, so that sound quality is deteriorated. At this time, since a phase difference of the sounds from the both speakers is changed according to a listening point, the sound quality is changed depending on the listening point.

FIG. 9 is a diagram showing one example of a situation of the interference of the sounds which is changed according to the listening point, which shows an example that, when listening to sound pressure levels of the sounds emitted from both of the mid-range speaker and the tweeter at different listening points, the sound pressure levels are changed.

In a case where there is a wavelength range A in which the bands of the sounds emitted from the mid-range speaker and the tweeter overlap in almost the same sound pressure level, in the wavelength region, when the listening point (position of a microphone for collecting sounds) is shifted, the sound pressure features are changed due to the interference, and this appears as the deterioration in sound quality.

By shifting the listening point, distances to the listening point from each of the mid-range speaker and the tweeter are changed. At this time, when sounds having a same wavelength are emitted from the both speakers, a phase difference of the sounds of this wavelength is changed in accordance with movement of the listening point, so that a state of the interference is changed. Accordingly, the sound pressure levels are changed depending on the listening point, resulting that the deterioration in sound quality is caused.

Against such a problem of sound quality deterioration by interfering of the sounds emitted from two speakers, for example, in a hi-fi audio system, a network circuit is constructed using a coil or a condenser in a configuration in which a mid-range speaker and a tweeter are used so that an unnecessary high-range sound in the mid-range speaker is interrupted as well as an unnecessary low-range sound in the tweeter is interrupted. Then, a band of the sound emitted from the mid-range speaker and a band of the sound emitted from the tweeter are thereby separated to perform prevention of the interference of the sounds from these two speakers.

However, even if the network circuit as above is configured, when an order of the network circuit is low, interruption of a sound in a target band becomes inadequate. Even more, in a case where these speakers are mounted in a television receiver having the above-described designing restriction or the like, arranging a coil on the network circuit is difficult due to, for example, restriction of a space or restriction in costs.

For example, as shown in a network circuit diagram of FIG. 10, in a configuration having a mid-range speaker M and a tweeter T, performed is only that a condenser C is simply installed in a tweeter T side to cut off a low range of the tweeter T for preventing the interference as much as possible. However, interruption of sounds in an interference band is inadequate even in this case, and the deterioration in sound quality is not able to be solved. In addition, as to a video display device such as a television receiver, requirement for a component cost is also severe, so that it is hardly possible to assemble the network circuit having an aimed performance of band interruption sufficiently.

Moreover, though it is also considered to adjust frequency features by using an equalizer which changes the frequency features via frequency transmission features of an electric circuit or signal processing on software, audio signals emitted from the mid-range speaker and the tweeter are audio signals having a same source, so that it is impossible to control a frequency band well even if such an equalizer is applied to those audio signals. Furthermore, though it is also considered to divide the audio signals having the same source into two and then perform the above-described processing by the equalizer for each audio signal, the restriction in a space, the restriction in costs, complexity and complication of a structure, or the like occurs, so that it is not practical.

As a result of them, the deterioration in sound quality due to the interference of the mid-range speaker and the tweeter is to be permitted.

The technology in Patent Literature 1 is for improving directivity of the speaker by providing the sound adjustment member for one speaker, and not applicable, in the above-described speaker system having two speakers for one amplifier channel, each of which emits a sound in a different band, to prevent the deterioration in sound quality thereof.

The present invention is devised in light of the above-described circumstances, and an object thereof is to provide a speaker system having two speakers for one amplifier channel, each of which emits a sound in a different band, in which, by including a configuration for effectively limiting the bands of the sounds emitted from the speakers without necessity of configuring a network circuit, acoustic features of high sound quality are able to be achieved without depending on a listening point, and a video display device provided with the speaker system.

### Means for Solving the Problem

To solve the above problems, a first technical means of the present invention is a speaker system comprising at least two speakers for one amplifier channel, each of which emits a sound in a different band, wherein a sound emission direction along a speaker axis of each speaker is set as front, a shielding object is included in the front of the speaker which emits a sound in a relatively low band side.

A second technical means is the speaker system of the first technical means, wherein the shielding object is arranged in front of a speaker central portion from which a sound having a frequency which is particularly high in the speaker from which the sound in the relatively low band side is emitted is concentratedly emitted.

A third technical means is the speaker system of the first technical means, wherein the shielding object forms openings having a total area having a predetermined size or more in front of a region from which the speaker in the relatively low band side emits a sound, and the openings are provided so as to be closer not to a center of a sound emission portion of the speaker emitting the sound in the low band side but to a side of the speaker emitting a sound in a relatively high band side.

A fourth technical means is the speaker system of the third technical means, wherein an opening having an area smaller than the predetermined size is provided in a side of the shielding object opposite to a side to which the openings are provided so as to be closer with respect to a center of the speaker emitting the sound in the low band side.

A fifth technical means is a video display device provided with the speaker system of any one of the first to the fourth technical means.

### Effects of the Invention

According to the present invention, it is possible to provide a speaker system having two speakers for one amplifier channel, each of which emits a sound in a different band, in which, by including a configuration for effectively limiting the bands of the sounds emitted from the speakers without necessity of configuring a network circuit, acoustic features of high sound quality are able to be achieved without depending on a listening point, and a video display device provided with the speaker system.

### BRIEF DESCRIPTION OF DRAWINGS

FIG. 1 is a schematic view showing a configuration of one embodiment of a speaker system of the present invention.

FIG. 2 is a diagram showing one example of sound pressure features depending on presence or absence of a shielding object.

FIG. 3 is a schematic view showing a configuration of another embodiment of a speaker system of the present invention.

FIG. 4 is a schematic view showing a configuration of still another embodiment of a speaker system of the present invention.

FIG. 5 is a schematic view showing a configuration of yet another embodiment of a speaker system of the present invention.

FIG. 6 is a diagram showing one example of sound pressure features depending on presence or absence of an opening smaller than a predetermined size.

FIG. 7 is a diagram showing one example of an external appearance configuration of a television receiver provided with the speaker system of the present invention.

FIG. 8 is a diagram showing one example of sound pressure features of a mid-range speaker and a tweeter.

FIG. 9 is a diagram showing one example of a situation of interference of sounds which is changed according to a listening point.

FIG. 10 is a diagram showing one example of a network circuit in which a condenser is simply provided.

### PREFERRED EMBODIMENT OF THE INVENTION

Description will hereinafter be given specifically for embodiments of a speaker system according to the present invention with reference to the accompanying drawings. Note that, in all of the drawings for the description of the embodiments, same reference numerals are assigned to parts which have same functions and repetitive description thereof will be omitted.

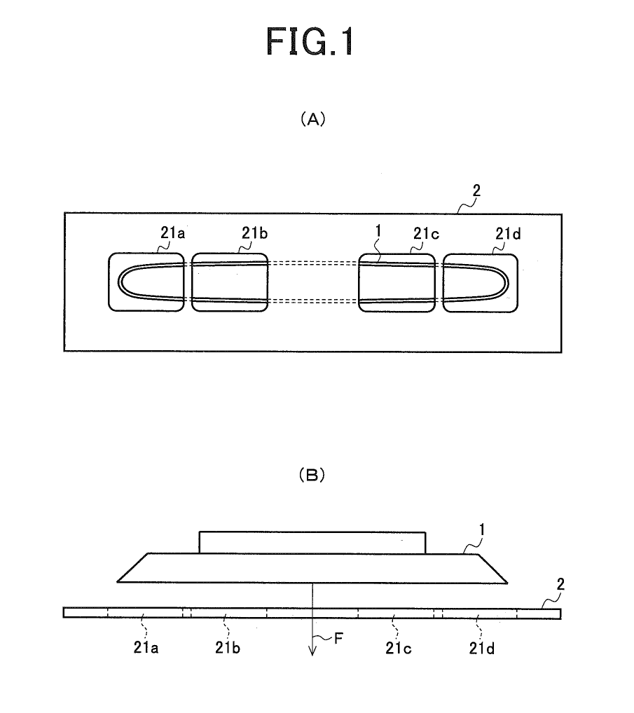

FIG. 1 is a schematic view showing a configuration of one embodiment of the speaker system of the present invention, and FIG. 1 (A) is a front schematic view of a mid-range speaker in which a shielding object is arranged and FIG. 1(B) is a top schematic view thereof. In FIG. 1, 1 denotes the mid-range speaker, 2 denotes the shielding object, and 21a to 21d denote openings in front of the speaker formed by the shielding object 2.

The speaker system of the present embodiment has two speakers for one amplifier channel, each of which emits a sound in a different band, and, as the two speakers, the mid-range speaker 1 which emits a sound in a relatively low band side and a tweeter which emits a sound in a relatively high band side (not shown in FIG. 1) are used.

Then, in the configuration of the present embodiment, when a sound emission direction F along a speaker axis of each speaker is set as front, the shielding object 2 is provided in the front of the mid-range speaker 1. The shielding object 2 is provided with the plurality of openings 21a to 21d, and a region which shields a front of a sound emission region (diaphragm region) of the mid-range speaker 1 by the shielding object 2 and a region for release by the openings 21a to 21d are formed. The openings 21a to 21d are provided for emitting sound from the mid-range speaker 1 to a listener side, and a total opening area of the openings 21a to 21d is to be a total area which has a predetermined size or more. Moreover, a shape or the number of the openings 21a to 21d is not limited and may be one that, for example, a plurality of round holes having small areas are gathered to form openings having the predetermined total area or more.

By including the shielding object 2, it is possible to shield a sound in a high-frequency band among sounds emitted from the mid-range speaker to prevent the sound in the high-frequency band from being emitted to the front. The high-frequency band has a small diffraction angle and attenuation by the shielding object 2 is large, so that it is possible to effectively attenuate the sound in the high-frequency band emitted from the mid-range speaker 1.

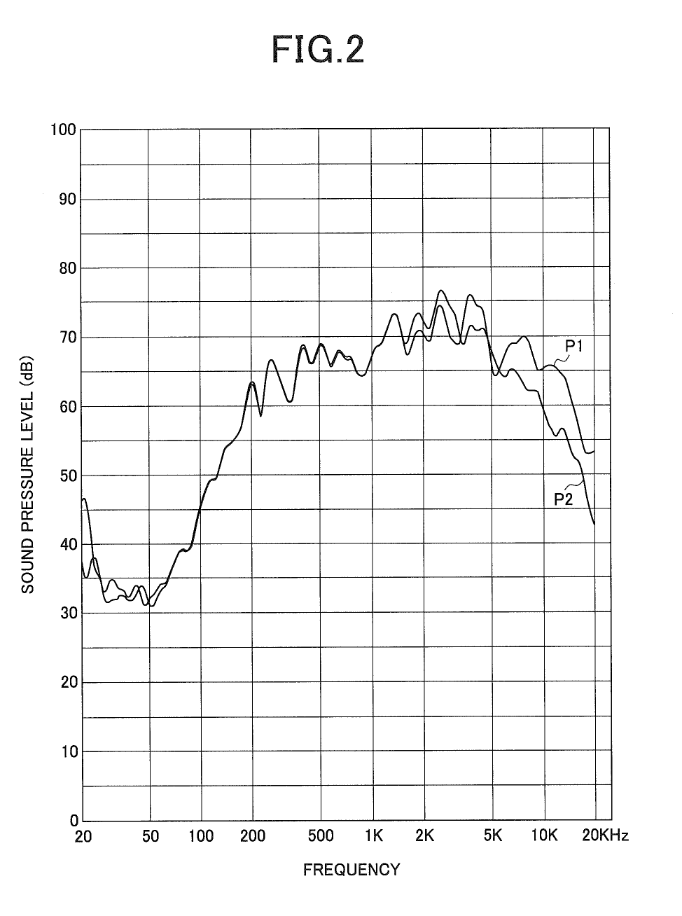

FIG. 2 is a diagram showing one example of sound pressure features depending on presence or absence of a shielding object, and P1 indicates an example of sound pressure features when the shielding object 2 is not provided in the front of the mid-range speaker 1 and P2 indicates an example of sound pressure features when the shielding object 2 is provided in the front of the mid-range speaker 1, in the diagram. As illustrated, by providing the shielding object 2 in the front of the mid-range speaker 1, it is possible to attenuate a sound pressure level of the high-frequency band. Thereby, in the speaker system provided with the mid-range speaker 1 and the tweeter, the sound pressure level in a high-frequency band side of the mid-range speaker is attenuated, so that a sound having a wavelength range overlapped in almost the same sound pressure level is reduced and audio deterioration due to interference becomes able to be suppressed.

Moreover, in the present embodiment, it is preferable that the above-described shielding object 2 is arranged so as to shield a front of a speaker central portion from which a sound having a relatively high frequency is concentratedly emitted. In a general speaker, a sound having a relatively high frequency is emitted concentratedly from a central portion thereof.

Accordingly, in order to effectively attenuate the sound of the high frequency band, when the front of the sound emission region of the mid-range speaker 1 is shielded with the shielding object 2, it is configured so that the front of the central portion of the mid-range speaker 1 is shielded. Thereby, it is possible to effectively attenuate only the sound of the high frequency band without affecting sounds in other bands emitted from the mid-range speaker 1. As a range of the central portion, a region of a predetermined range including a center of the mid-range speaker 1 is able to be set. Moreover, the region of the central portion at this time may not have a symmetrical shape but have a shape having a region which is deviated from the center of the speaker in any direction.

By the above-described configuration, the interference of the sound from the mid-range speaker 1, in which the sound of the high frequency band has been effectively attenuated, with the sound emitted from the tweeter is prevented, making it possible to emit a sound with a satisfactory sound quality.

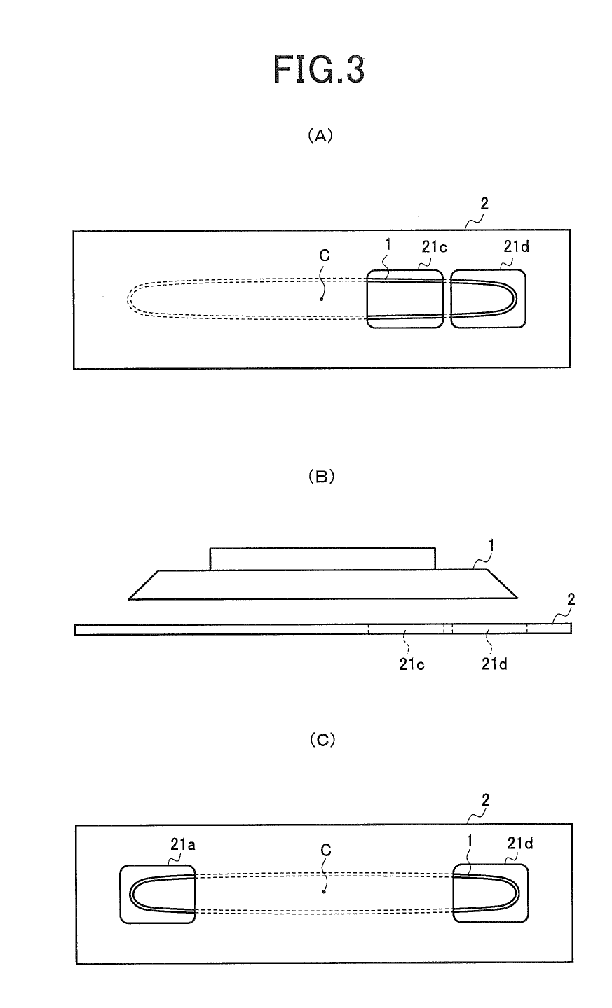

FIG. 3 is a schematic view showing a configuration of still another embodiment of the speaker system of the present invention. In the present embodiment, the shielding object 2 is arranged so as not to include openings which have a predetermined size or more in, among a front region of a region from which the mid-range speaker 1 emits a sound, both of regions in both sides of the center of the speaker, which emits a sound in a relatively low frequency band side. FIG. 3 (A) is a front schematic view of the mid-range speaker in which the shielding object at this time is arranged and FIG. 3 (B) is a top schematic view thereof.

In this example, in one side of a center c of the mid-range speaker 1, the openings 21c and 21d formed by the shielding object 2 are provided. The center c is, for example, a point-symmetric center of a diaphragm region of the mid-range speaker 1. With this configuration, the openings are not dispersed in the both sides of the center c of the mid-range speaker 1, and the openings are provided so as to be aggregated, so that sounds emitted through respective openings 21c and 21d do not interfere with each other, thus making it possible to emit the sounds with high sound quality. Moreover, at this time, it is configured so that the shielding object 2 shields the front of the speaker central portion including the center c of the mid-range speaker 1, thus making it possible to obtain an effect to effectively attenuate only the sound of the high frequency band.

FIG. 3 (C) shows an undesirable example of an arrangement of the openings formed by the shielding object 2. As shown in this figure, two openings 21a and 21d are provided so as to be dispersed in the both sides of the center c of the mid-range speaker 1. In this case, a distance from right to left between the openings 21a and 21d is long, and a difference of distances to a listening point is generated, so that possibility to cause interference becomes high. On the other hand, by providing the openings in the one side with respect to the center c as FIG. 3(A) and FIG. 3(B) above, it is possible to suppress the interference due to sounds emitted from the openings.

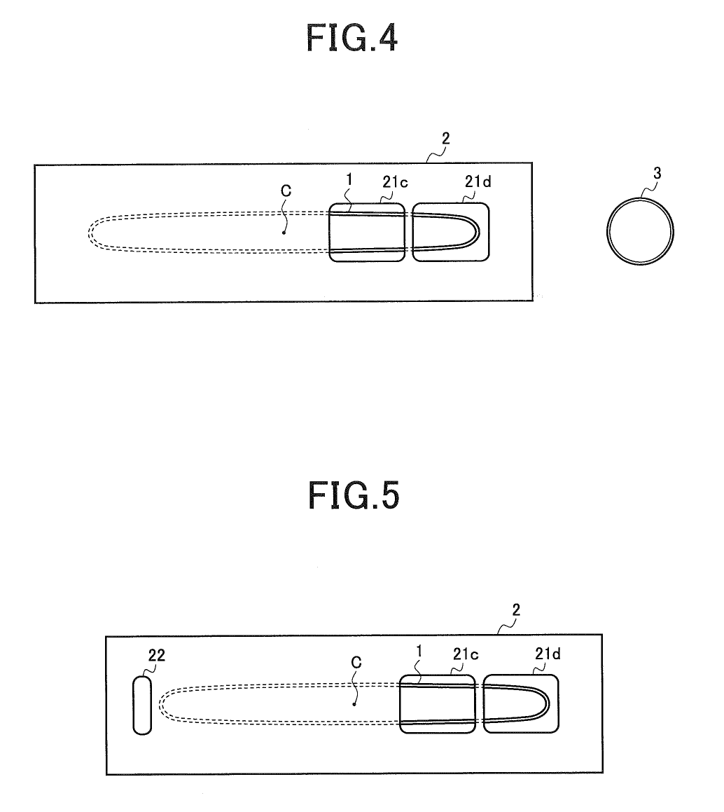

FIG. 4 is a schematic view showing a configuration of still another embodiment of the speaker system of the present invention. In FIG. 4, in addition to the configuration of the mid-range speaker 1 and the shielding object 2 of FIG. 3, a tweeter 3 which the speaker system has is shown. In the embodiments according to the present invention, the mid-range speaker 1 and the tweeter 3 are provided per one amplifier channel for outputting an audio signal. Accordingly, in the case of a speaker system which outputs audio signals of two channels, the mid-range speakers 1 and the tweeters 3 are provided one by one for one amplifier channel, i.e. two of them in total are respectively provided.

Then, in the present embodiment, similarly to the configuration of FIG. 3, the shielding object 2 is provided in the front of the mid-range speaker 1, and the shielding object 2 forms the openings 21c and 21d having the total area which has the predetermined size or more in the front of the region from which the mid-range speaker 1 emits a sound. The openings 21c and 21d are provided so that the openings 21c and 21d are not provided in the both regions of the both sides of the center c of the mid-range speaker 1. In the present embodiment, the openings 21c and 21d are provided so as to be closer not to the center c of a sound emission portion of the mid-range speaker 1 but to a tweeter 3 side.

Even in a case where the shielding object 2 is arranged so as to shield the front of the central portion of the mid-range speaker 1 and the openings 21c and 21d formed by the shielding object 2 are arranged so as to be closer to one side from the center c of the mid-range speaker 1 as described above, there is still possibility of interference in a region where frequencies of sounds emitted from the mid-range speaker 1 and the tweeter 3 are overlapped. It is difficult to deal with a case where sound pressure is attenuated due to the interference.

In the present embodiment, the openings 21c and 21d provided in the one side with respect to the center c of the mid-range speaker 1 are therefore provided so as to be closer not to the center c of the sound emission portion of the mid-range speaker 1 but to the tweeter 3 side. Thereby, a distance between the openings 21c and 21d from which the sound from the mid-range speaker 1 is emitted and the tweeter 3 becomes short, and, even when sounds in a same frequency band are emitted with almost the same sound pressure, a distance difference to a listening point is difficult to be generated, making it possible to suppress attenuation of the sounds due to interference.

For example, consideration is made on a relation between a frequency when phases of sounds emitted from the mid-range speaker 1 and the tweeter 3 become opposite phases to each other for mutual cancellation and a distance between the mid-range speaker 1 and the tweeter 3.

Here, in a case where there is a distance d1 between the mid-range speaker 1 and a listening point and a distance d2 between the tweeter 3 and the listening point, and theoretically in a case where a distance difference between the d1 and the d2 is about 2.125 cm, sounds become completely opposite phases only after being emitted from each of the speakers with 8 kHz and do not become opposite phases in a frequency substantially lower than that and hardly cause the interference for mutual cancellation. This is because, when assuming that a sound velocity is about 340 m/second, a relational expression of 340 m/second÷8000 Hz÷2=2.125 cm is established. On the other hand, in a case where the distance difference between the d1 and the d2 becomes short as about 1.0625 cm, sounds become completely opposite phases only after being emitted from each of the speakers with 16 kHz and do not become opposite phases in a frequency substantially lower than that and hardly cause the interference for mutual cancellation.

That is, the shorter the distance difference of the distances from each speaker becomes, the closer to a high frequency side a frequency in which the interference is possible to occur becomes. The shorter distance difference means that a distance from each speaker becomes short. Then, in this case, since an output sound pressure level of the mid-range speaker 1 is substantially attenuated in the frequency band in which the interference for mutual cancellation is possible to occur, it is possible to greatly reduce attenuation due to the interference with the tweeter 3. As above, by providing the openings of the shielding object 2 from which the sound from the mid-range speaker 1 is emitted so as to be closer to the tweeter 3 side for shortening distances between the openings and the tweeter 3, it is possible to suppress reduction of sound quality due to the interference of sounds emitted from each speaker.

FIG. 5 is a schematic view showing a configuration of yet another embodiment of the speaker system of the present invention. In the present embodiment, in a configuration in which the openings 21c and 21d having the total area which has the predetermined size or more are formed in the shielding object 2 in the front of the mid-range speaker 1 as shown in FIG. 3 and FIG. 4 above so that the openings 21c and 21d are not provided in the both regions of the both sides of the center c of the mid-range speaker 1, an opening 22 having an area smaller than the predetermined size is provided in a side of the shielding object opposite to the side to which the openings 21c and 21d are provided so as to be closer with respect to the center c of the mid-range speaker 1.

This opening 22 is provided in the opposite side to the openings 21c and 21d having the total area which has the predetermined size or more with respect to the center c of the mid-range speaker 1, and is able to be provided in a vicinity of a space between the shielding object 2 and the mid-range speaker 1. As shown in FIG. 5, the opening 22 is provided in a vicinity of an outer side of a front region of the mid-range speaker 1, but may be provided in the front region of the mid-range speaker 1. By providing this opening 22, it is possible to reduce stiffness of the above-described space (air firmness) formed by the shielding object 2, thereby making it possible to prevent reduction of sound pressure throughout the entire frequency band which results from the stiffness of the space.

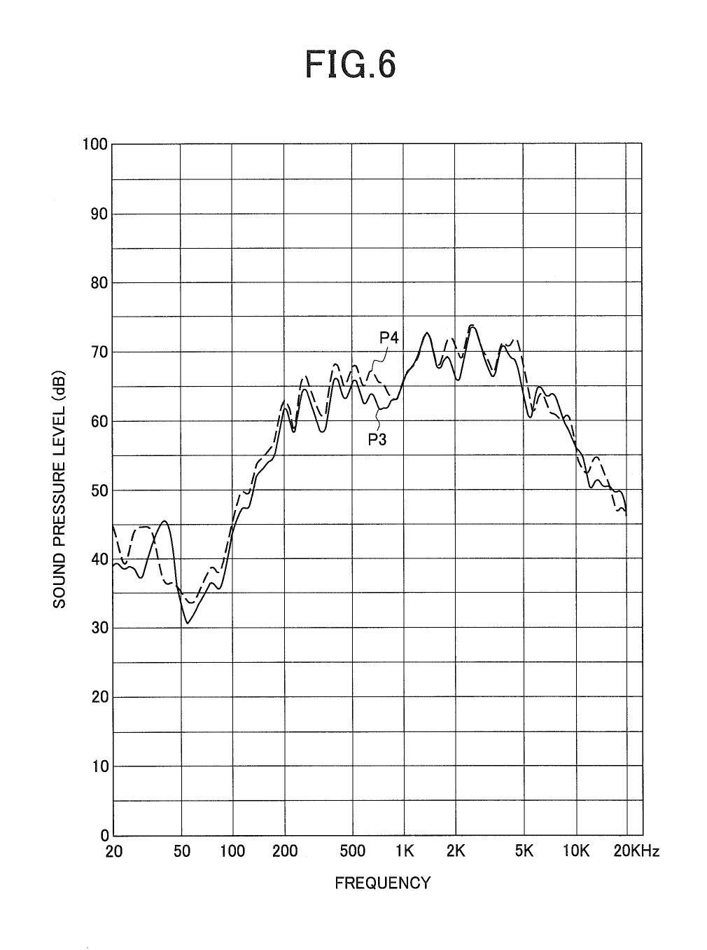

FIG. 6 is a diagram showing one example of sound pressure features depending on presence or absence of the opening for improving the stiffness of the space, and, in the diagram, P3 indicates an example of sound pressure features when the opening 22 smaller than the predetermined size is not provided in the shielding object 2 and P4 indicates an example of sound pressure features when the shielding object 2 is provided in the front of the mid-range speaker 1.

As illustrated, by providing the opening 22 smaller than the predetermined size for improving the stiffness of the space in the side opposite to the openings having the total area which has the predetermined size or more with respect to the center of the mid-range speaker 1, it is possible to improve the reduction of sound pressure throughout the entire frequency band and enhance a sound pressure level, thereby making it possible to contribute to enhancement of sound quality.

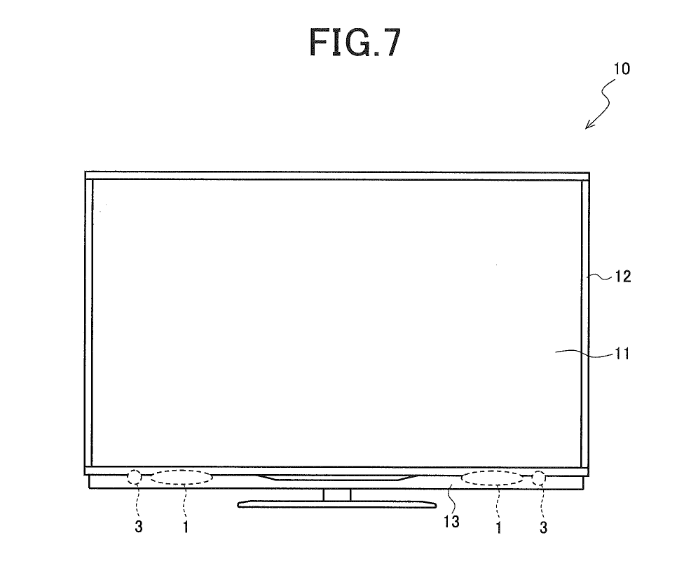

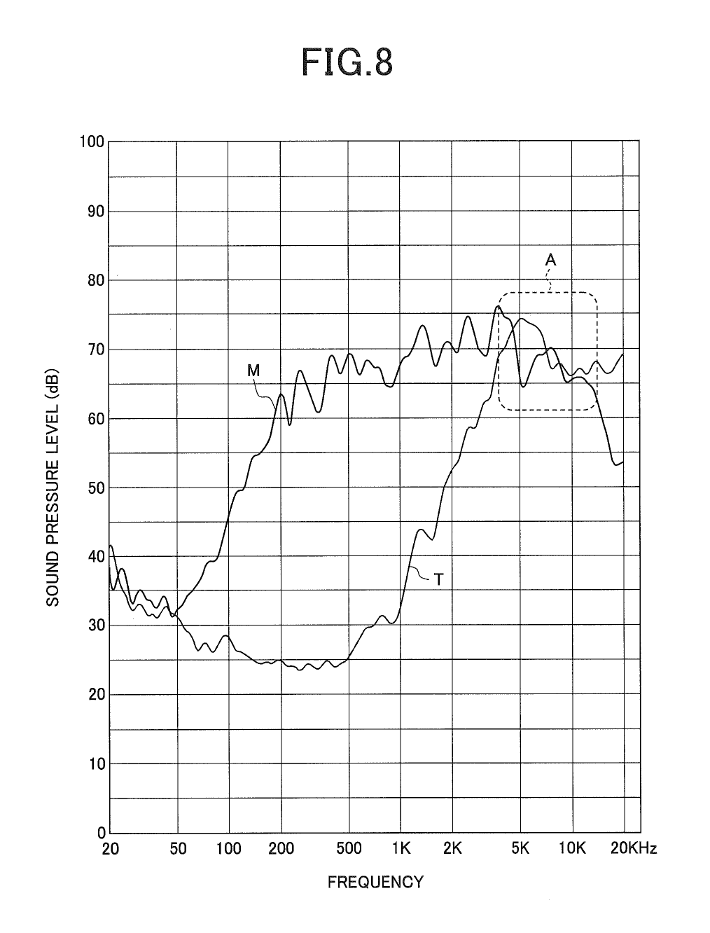

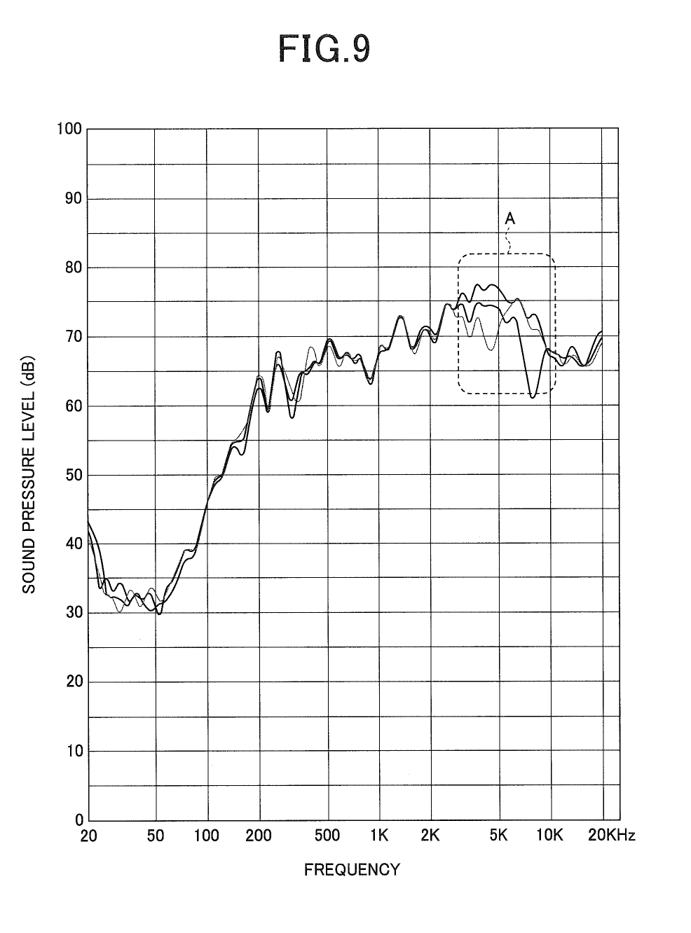

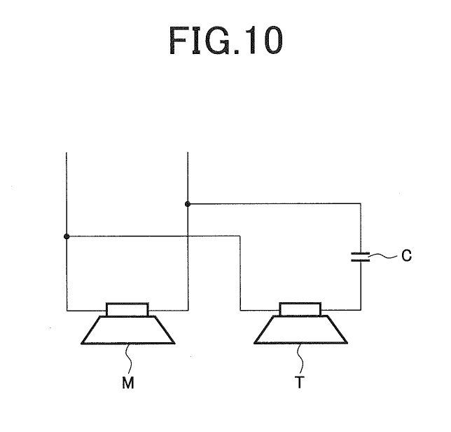

FIG. 7 is a diagram showing one example of an external appearance configuration of a television receiver which is one of the video display devices provided with the speaker system of the present invention. A television receiver 10 is provided with a front frame 12 around a front surface of a display portion 11 using a liquid crystal panel or the like. The front frame 12 configures a frame of the display portion 11, and so-called frame-narrowing with which this frame is narrow has proceeded in recent years. Moreover, each of optical elements and electric and electronic elements of the television receiver 10 including the display portion 11, the speaker system including the mid-range speaker 1 and the tweeter 3 and the like are contained inside a housing 13. This television receiver 10 has means for selecting and demodulating a broadcast signal received by an antenna to decode for generating a video signal for reproduction and an audio signal for reproduction, and has functions of applying predetermined image processing to the video signal for reproduction as appropriate for display on the display portion 11 as well as of causing the audio signal for reproduction to be subjected to audio output from the speaker system.

The speaker system provided in the television receiver 10 is able to employ the configuration of each embodiment described above, and is configured as the speaker system that has two speakers for one amplifier channel, each of which emits a sound in a different band. These two speakers are able to be provided with a mid-range speaker which emits a sound in a relatively low band side and a tweeter which emits a sound in a relatively high band side. Moreover, in addition to them, a woofer which is in charge of a still lower frequency region is able to be provided.

Then, in one embodiment of the present invention, the shielding object 2 which shields the front of the above-described mid-range speaker 1 is able to be provided as a part of the housing 13. That is, the mid-range speaker 1 and the tweeter 3 are provided in a predetermined position inside the housing 13, and, as the part of the housing 13, the shielding object 2 is provided in a front face side of the mid-range speaker 1 in the configuration shown in each embodiment described above. Thereby, without necessity of further adding an excessive member to the television receiver 10 and with thinning and frame-narrowing are maintained, it is possible to effectively arrange the shielding object 2.

Note that, technical characteristics described in each embodiment above may be combined with each other and may form other technical characteristics by the combination.

In a speaker system having at least two speakers for one amplifier channel, each of which emits a sound in a different band, when a sound emission direction along a speaker axis of each speaker is set as front, the speaker system may be one that has a shielding object in the front of the speaker which emits a sound in a relatively low band side. Thereby, by including a configuration for effectively limiting the bands of the sounds emitted from the speakers without necessity of configuring a network circuit, it is possible to enable to achieve acoustic features of high sound quality without depending on a listening point.

Moreover, the speaker system may be one in which the above-described shielding object is arranged in front of a speaker central portion from which a sound having a frequency which is particularly high in the speaker from which the sound in the relatively low band side is emitted is concentratedly emitted. Thereby, it is possible to effectively attenuate only a sound of a high frequency band without affecting sounds in other bands emitted from the mid-range speaker 1.

Moreover, the speaker system may be one in which the above-described shielding object is arranged so as not to include openings having a total area which has a predetermined size or more in, among a front region of a region from which the speaker emitting the sound in the low band side emits the sound, both of regions in both sides of a center of the speaker. Thereby, the openings are not dispersed in the both sides of the center of the mid-range speaker 1, and the openings are provided so as to be aggregated, so that sounds emitted through respective openings do not interfere with each other, making it possible to emit the sounds with high sound quality.

Moreover, the speaker system may be one in which the above-described shielding object forms openings in the front of the region from which the speaker in the relatively low band side emits the sound and the openings are provided so as to be closer not to a center of a sound emission portion of the speaker emitting the sound in the low band side but to a side of the speaker emitting a sound in a relatively high band side. Thereby, distances between the openings from which the sound from the mid-range speaker 1 is emitted and the tweeter 3 becomes short, and, even when sounds in a same frequency band are emitted with almost the same sound pressure, a distance difference to a listening point is difficult to be generated, making it possible to suppress attenuation of sounds due to interference.

Moreover, the speaker system may be one in which an opening having an area smaller than the predetermined size is provided in a side of the shielding object opposite to a side to which the openings are provided so as to be closer with respect to a center of the sound of the speaker emitting the sound in the low band side. Thereby, it is possible to reduce stiffness of a space (air firmness) formed by the shielding object 2, thereby making it possible to prevent reduction of sound pressure throughout the entire frequency band which results from the stiffness of the space.

Moreover, the speaker system may be one in which a housing for containing each speaker is included and the above-described shielding object is provided as a part of the housing. Thereby, in the configuration that the speaker system is contained in the housing, without necessity of further adding an excessive member for the shielding object and with miniaturization of the housing or the like is maintained, it is possible to effectively arrange the shielding object.

Moreover, by including the above-described speaker system, it is possible to provide a video display device which is able to achieve acoustic features of high sound quality without depending on the listening point.

### EXPLANATIONS OF LETTERS OR NUMERALS

1 . . . mid-range speaker, 2 . . . shielding object, 3 . . . tweeter, 10 . . . television receiver, 11 . . . display portion, 12 . . . front frame, 13 . . . housing, 21a to 21d . . . opening, and 22 . . . opening.

1. A speaker system comprising at least two speakers for one amplifier channel, each of which emits a sound in a different band, wherein
a sound emission direction along a speaker axis of each speaker is set as front,
a shielding object is included in the front of the speaker which emits a sound in a relatively low band side.

2. The speaker system according to claim 1, wherein
the shielding object is arranged in front of a speaker central portion from which a sound having a frequency which is particularly high in the speaker from which the sound in the relatively low band side is emitted is concentratedly emitted.

3. The speaker system according to claim 1, wherein
the shielding object forms openings having a total area having a predetermined size or more in front of a region from which the speaker in the relatively low band side emits a sound, and the openings are provided so as to be closer not to a center of a sound emission portion of the speaker emitting the sound in the low band side but to a side of the speaker emitting a sound in a relatively high band side.

4. The speaker system according to claim 3, wherein
an opening having an area smaller than the predetermined size is provided in a side of the shielding object opposite to a side to which the openings are provided so as to be closer with respect to a center of the speaker emitting the sound in the low band side.

5. A video display device provided with the speaker system according to claim 1.
